(19) United States
(12) Patent Application Publication
(10) Pub. No.: US 2016/0156111 A1
(43) Pub. Date: Jun. 2, 2016

(54) ELECTRICAL GROUND ASSEMBLY FOR A VEHICLE

(71) Applicant: FORD GLOBAL TECHNOLOGIES, LLC, Dearborn, MI (US)

(72) Inventor: Matthew FORSYTH, Detroit, MI (US)

(21) Appl. No.: 14/557,954

(22) Filed: Dec. 2, 2014

(51) Int. Cl. H01R 4/06; H01R 13/648; H01R 4/02

(52) U.S. Cl. CPC H01R 4/06; H01R 4/02; H01R 13/648

(57) ABSTRACT

An electrical ground assembly includes a vehicle component defining a hole, and a fastener. The fastener includes a flange defining an aperture extending completely therethrough, and a barrel disposed within the hole. The barrel includes a compressed annular locking ring engaged with a side of the component opposite the flange to form a mechanical interlock. Solder is disposed within the aperture to form an electrical bridge between the component and the fastener.

### TECHNICAL FIELD

The present disclosure relates to an electrical ground assembly for attachment to automotive vehicle components, and more particularly, to electrical ground assemblies that do not require welding.

### BACKGROUND

The current regulatory and economic environment has increased the importance of motor vehicle fuel efficiency and functionality. One way to reduce the fuel consumption of a vehicle is to reduce vehicle weight. Aluminum alloys typically have a higher strength to weight ratio than steel alloys. Replacing steel with aluminum offers the potential for weight reduction.

Vehicle electrical systems may include a ground wire attached to the vehicle frame or other vehicle component with an electrical ground assembly. The typical ground assembly includes a nut welded to a steel vehicle component. The ground wire is typically attached to an eyelet that receives a bolt threaded into the nut. In order to create a strong electrical connection, the nut is typically welded to the vehicle component.

Aluminum components have limited compatibility with welding. Welding aluminum, for example, is expensive. Other fasteners, such as rivet-nuts, which do not require welding, are better suited for aluminum components. The fasteners are attached to the aluminum component by a mechanical interlock created during installation of the fastener. The mechanical interlock provides a strong mechanical connection but does not provide sufficient electrical conductivity between the fastener and the vehicle component to provide a satisfactory electrical ground.

### SUMMARY

In one embodiment, an electrical ground assembly includes a vehicle component defining a hole, and a fastener. The fastener includes a flange defining an aperture extending completely therethrough, and a barrel disposed within the hole. The barrel includes a compressed annular locking ring engaged with a side of the component opposite the flange to form a mechanical interlock. Solder is disposed within the aperture to form an electrical bridge between the component and the fastener.

In another embodiment, a fastener for a vehicle includes an electrical ground rivet nut having a tubular barrel and a flange attached to the barrel. The barrel includes a sidewall configured to buckle, during installation, to form a compressed annular locking ring. The flange defines at least one notch extending completely through the flange.

In yet another embodiment, an electrical ground assembly includes a vehicle component and a fastener. The fastener includes a coupling portion and a riveting portion that are axially aligned and separated by a flange. The flange defines an aperture extending completely therethrough. The riveting portion is configured to, during installation, pierce through the component and deform to create a mechanical interlock with the component. Solder is disposed within the aperture, and joined to the component and the fastener to form an electrical bridge therebetween.

### BRIEF DESCRIPTION OF THE DRAWINGS

FIG. 1 is a perspective view of an electrical ground rivet-nut.

FIG. 2 is a cross-sectional view of the electrical ground rivet-nut of FIG. 1.

FIG. 3 is a cross-sectional view of the electrical ground rivet-nut of FIGS. 1 and 2 being installed on a vehicle component by an installation tool.

FIG. 4 is a cross-sectional view of an electrical ground assembly that includes the electrical ground rivet-nut of FIGS. 1 through 3.

FIG. 5 is a perspective view of an electrical ground assembly having an electrical ground rivet-stud.

FIG. 6 is a section view along cut line 6-6.

FIG. 7 is a perspective view of another electrical ground fastener.

FIG. 8 is a perspective view of an electrical ground assembly having the fastener of FIG. 7.

FIG. 9 is a perspective view of yet another electrical ground fastener.

FIG. 10 is a perspective view of an electrical ground assembly having the fastener of FIG. 9.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

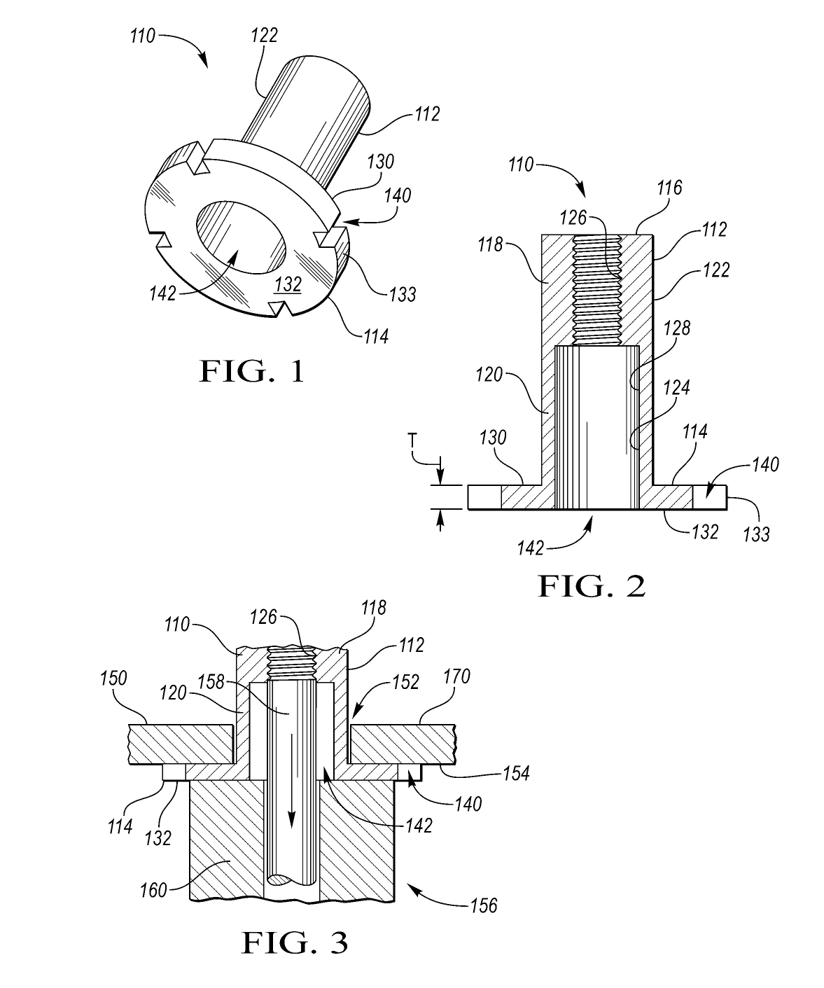

Referring to FIGS. 1 and 2 an electrical ground rivet-nut 110 is illustrated. The electrical ground rivet-nut 110 is a fastener that combines a rivet with a threaded receptacle. Rivet-nuts allow a threaded receptacle to be attached to component surfaces where nuts and tapped holes are impractical. An example application for fastener 110 is on thin-walled components having only one sided access. The one sided access prevents a nut or other threaded component from being attached to the inner side of the component, and the thin wall prevents a tapped hole from being used. The fastener 110 can be attached to the thin wall and provide a threaded sleeve for receiving another fastener. The fastener 110 is advantageous for aluminum components because it does not require welding for attachment.

The fastener 110 includes a tubular barrel 112 that is connected to a flange 114 at one end of the barrel 112. The barrel 112 may have a circular cross-section. The barrel 112 includes a sidewall 116 having a threaded section 118 and a crush section 120. The sidewall 116 has an outer surface 122 and an inner surface 124 that defines an inner cavity. The sidewall inner surface 124 has a threaded portion 126 extending along the threaded section 118 and a substantially smooth portion 128 extending along the crush section 120. The threaded section 118 has a first wall thickness defined between the outer surface 122 and the inner surface thread portion 126. The crush section 120 has a second wall thickness defined between the smooth inner surface 128 and the outer surface 122. The first sidewall thickness is thicker than the second sidewall thickness. The thickness of the sidewall 116 may abruptly change between the threaded section and the crush section, as is shown in FIG. 2, or may have a transitional tapering thickness between the threaded section and the crush section.

The flange 114 may be a planar annular body including a component engaging surface 130 and an exposed surface 132 that is opposite the component engaging surface 130. A periphery surface 133 extends between the component engaging surface 130 and the exposed surface 132. The sidewall inner surface 124 extends through the flange 114 and defines an opening 142 in the exposed surface 132. The flange 114 includes a thickness T defined between the component engaging surface 130 and the exposed surface 132.

The flange 114 defines at least one aperture 140 extending completely through the thickness of the flange. In the illustrated embodiment, the flange 114 includes four notches 140 equally spaced around the perimeter of the flange 114. Each notch 140 may be recessed into the periphery surface 133 and extends between the component engaging surface 130 and the exposed surface 132. In other embodiments, the aperture 140 may be a circular hole located inward of the perimeter of the flange 114.

Referring to FIG. 3, a vehicle component 150 includes an outer surface 154 and an inner surface 170. The vehicle 150 component may be an aluminum alloy. A hole 152 is defined into the component 150 and extends between the outer surface 154 and the inner surface 170. The barrel 112 is received within the hole 152 with the component engaging surface 130 facing the outer surface 154.

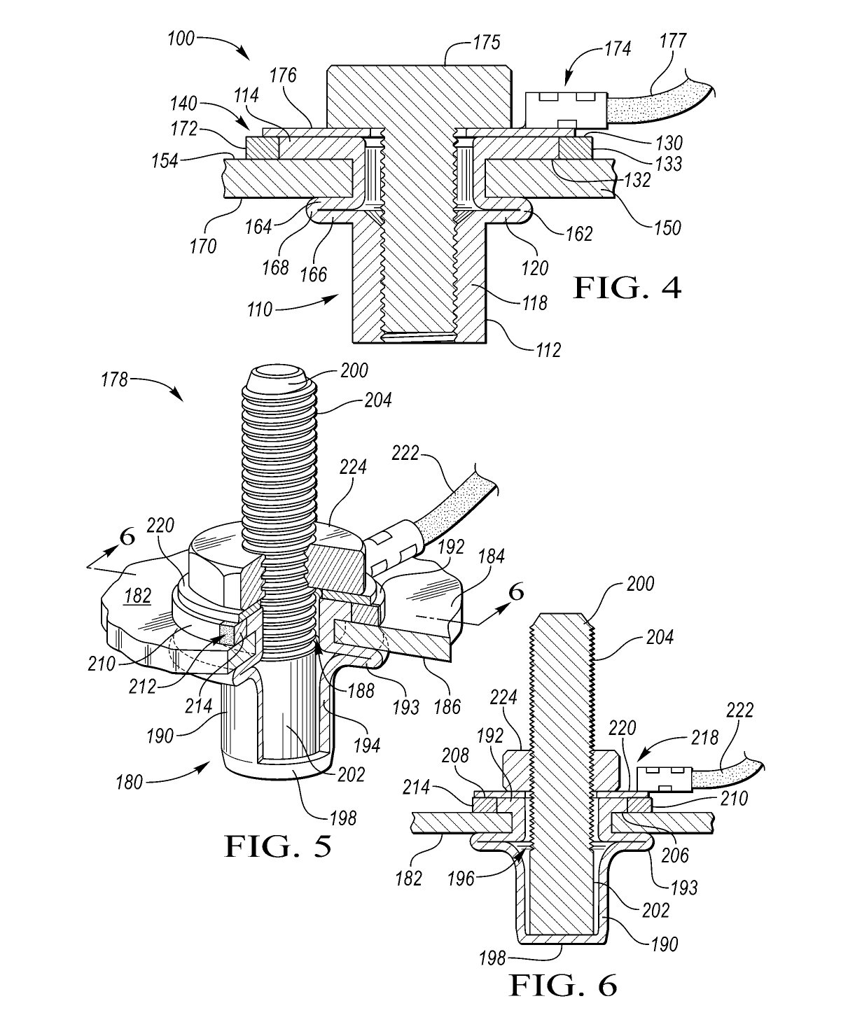

An installation tool 156 is used to secure the fastener 110 to the component 150. The installation tool 156 may include an engaging member 160 and a mandrel 158 that is configured to slide relative to the engaging member 160. The mandrel 158 includes threads that correspond to threads in the threaded section 118. The engaging member 160 is configured to engage the exposed surface 132 of the flange 114. The mandrel 158 is inserted though the opening 142 and is screwed into the threaded section 118. The engaging member 160 is placed against the exposed surface 132 of the flange 114 to hold the fastener 110 in place while the mandrel 158 is pulled out of the barrel 112. The mandrel 158 is pulled out of the barrel causing the crush section 120 to buckle. The buckled crush section integrally forms a crushed annular locking ring 162 that is axially compressed and radially expanded. (See FIG. 4). The crushed annular locking ring 162 extends around the periphery of the barrel 112.

Referring to FIG. 4, an electrical ground assembly 100 is shown. The assembly includes a fastener 110 attached to the vehicle component 150. The annular locking ring 162 creates a mechanical interlock with the component 150 to secure the fastener 110 to the component 150. The locking ring 162 includes a first overlapping section 164 and a second overlapping section 166 that join at a bend 168. The first overlapping section 164 engages with an inner surface 170 of the component 150 to clamp the component between the first overlapping portion 164 and the flange 114.

The fastener 110 may be soldered to the component 150 to create an electrical bridge between the two. Soldering is a process in which two or more metal items are joined together by melting and flowing a filler metal (solder) into the joint. Soldering differs from welding in that soldering does not involve melting the work pieces. Instead, the solder (which has a melting point below that of the work pieces) melts and bonds to the work pieces. Soldering is well suited for aluminum applications because welding aluminum is difficult and expensive. Used herein, solder refers to a metal alloy having a melting point below 840 degrees Celsius. The term soldering includes soft soldering, silver soldering and brazing.

Solder 172 is disposed within each notch 140 to create an electrical bridge between the fastener 110 and the component 150. The notches 140 provide access for soldering as well as a pocket for the solder to be deposited. Without the notches 140, solder could only be attached around the periphery of the flange 114. This is a small interface and does not have a pocket. Because of these deficiencies, soldering only around the periphery of the flange 114 is not practical for mass production. While not shown, solder may be applied around the periphery of the flange 114 to provide additional electrical conductivity.

The ground assembly 100 may include a grounding lug 174 that is electrically connected to the circuitry of a vehicle electrical system. The grounding lug 174 may include an eyelet 176 that is attached to the fastener 110 with a bolt or screw 175. A wire 177 is attached to the eyelet 176 at one end and is attached to the circuitry at the other end.

Referring to FIGS. 5 and 6, an electrical ground assembly 178 includes an electrical ground rivet-stud 180 is attached to a vehicle component 182. The vehicle component 182 includes an exposed side 184 and an interior side 186. The component 182 may be an aluminum alloy. A hole 188 is defined within the component 182 and extends between the exposed side 184 and the interior side 186. The fastener 180 includes a tubular barrel 190 and a flange 192. The tubular barrel 190 includes a sidewall 194 having an outer surface and an inner surface. The barrel 190 includes a crush portion that is configured to buckle into an annular locking ring 193 when the fastener 180 is installed onto the component 182 forming a mechanical interlock with the component 182. The tubular barrel 190 and flange 192 define a bore 196 extending within the fastener 180. The tubular barrel 190 includes a closed end 198 opposite the flange 192 that defines a ceiling of the bore 196. A threaded stud 200 is partially received within the bore 196 and extends out of the bore 196 past the flange 192. The stud 200 includes a smooth surface 202 located within the barrel and a coupling surface 204 extending along the portion outside of the fastener. The stud 200 may be attached to the barrel at the closed end 148 and along a portion of the inside surface of the barrel 190.

The flange 192 includes a first surface 206 that engages with the exposed side 184 and a second surface 208 that is opposite the first surface 206. A periphery surface 210 extends between the first and second surfaces 206, 208. The flange 192 defines at least one aperture 212, such as a plurality of notches. Each notch 212 may be recessed into the periphery surface 210 and extend between the first and second surfaces 206, 208. The notches 212 provide an area for receiving solder 214 to create a strong electrical connection between the fastener 180 and the vehicle component 182. Without the notches, solder can only be placed along a thin interface of the flange and component, which is insufficient to provide a reliable electrical connection in mass production.

The electrical ground assembly 178 includes a grounding lug 218 that is electrically connected to the circuitry of a vehicle electrical system. The grounding lug 218 may include an eyelet 220 received onto the stud 200. A wire 222 is attached to the eyelet 220 at one end and is attached to the circuitry at another end. A threaded nut 224 is disposed over the grounding lug 218 and engages with the coupling surface 204 to secure the grounding lug 218 to the fastener 180.

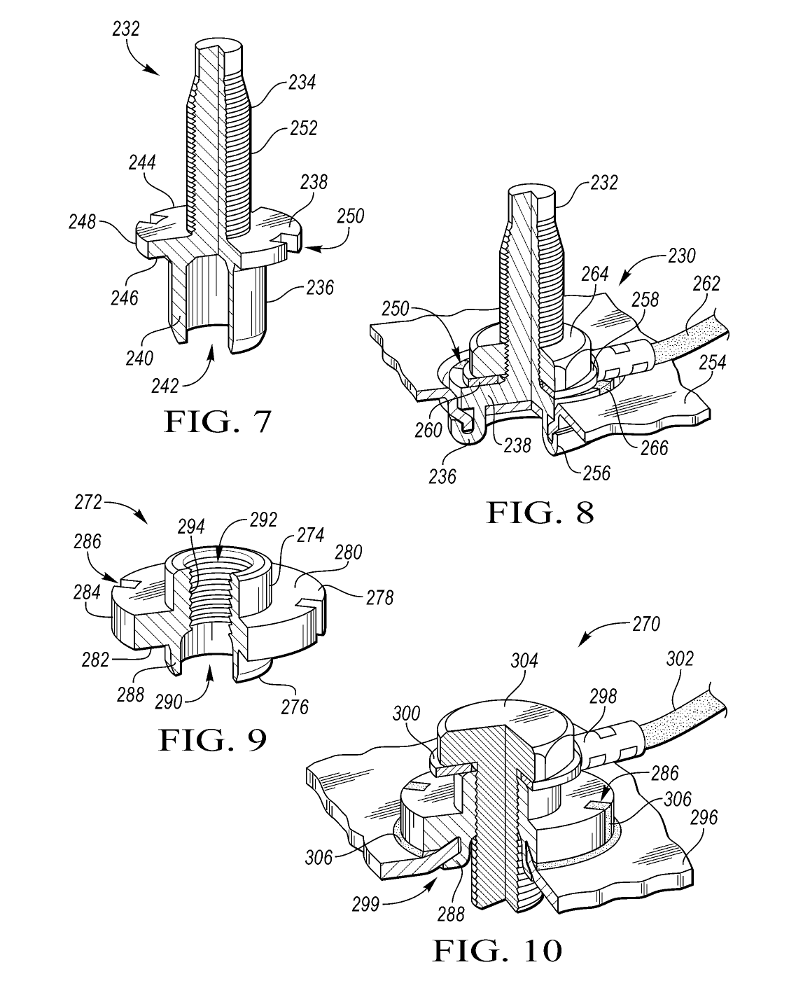

FIGS. 7 and 8 illustrate another electrical ground assembly 230 that includes a fastener 232 having a coupling portion 234 and a riveting portion 236. The coupling portion and the riveting portion are axially aligned along a common centerline and are separated by a flange 238. The coupling portion 234, riveting portion 236 and flange 238 may be integrally formed as a single component. The flange 238 includes a first surface 244 and a second surface 246 that is opposite the first surface 244. A periphery surface 248 extends between the first and second surfaces 244, 246. The flange 238 also includes at least one aperture 250 extending completely through the flange 238. For example, the at least one aperture 250 may be a plurality of notches that are recessed into the periphery surface 248 and extend between the first and second surfaces 244, 246. The notches 250 are configured to receive. The riveting portion 236 includes a tubular wall 240 defining an inner cavity 242. The coupling portion 234 may be a stud extending from the flange 238. The stud may include threads 252.

The fastener 232 may be a self-piercing fastener that is driven into a vehicle component 254. The vehicle component 254 may be an aluminum alloy. Alternatively, the fastener 232 may be received within a hole defined within the component 254. The fastener 232 may be installed by driving the riveting portion 236 into a panel of the component 254. The tubular wall 240 pierces through the panel and deforms to create a mechanical interlock 256 with the component 254. When installed, the second surface 246 of the flange 238 is adjacent to the component 254 and the coupling portion 234 extends outwardly away from the component 254. After the fastener 232 is installed onto the component 254, solder 266 is deposited within the notches 212 to create a strong electrical connection between the fastener 232 and the vehicle component 254. The fastener 232 may also be soldered to the component 254 along the periphery of the flange 238.

The ground assembly 230 also includes a grounding lug 258 electrically connected to the circuitry of a vehicle electrical system. The grounding lug 258 may include an eyelet 260 that is received onto the coupling portion 234 to ground the circuitry to the component 254. A wire 262 is connected to the eyelet 260 at one end is connected to the circuitry at the other end. The grounding lug 258 may be secured to the fastener 232 with a nut 264 that is threaded onto the coupling portion 234.

FIGS. 9 and 10 illustrate yet another vehicle electrical ground assembly 270 that includes a fastener 272 having a coupling portion 274 and a riveting portion 276. The coupling portion and the riveting portion are axially aligned along a common centerline and are separated by a flange 278. The coupling portion 274, riveting portion 276 and flange 278 may be integrally formed as a single component. The flange 278 includes a first surface 280 and a second surface 282 that is opposite the first surface 280. A periphery surface 284 extends between the first and second surfaces. The flange 278 also includes at least one aperture 286 extending completely through the flange 278. For example, the least one aperture 286 may be a plurality of notches that are recessed into the periphery surface 284 and extend between the first and second surfaces 280, 282. The notches 286 are configured to receive solder. The riveting portion 276 includes a tubular wall 288 defining an inner cavity 290. The coupling portion 274 defines a bore 292 that may include threads 294.

The fastener 272 may be installed by driving the riveting portion 276 into a panel of a vehicle component 296. The tubular wall 288 is received through the panel and deforms to create a mechanical interlock 299 with the component 296. When installed, the second surface 282 of the flange 278 is adjacent to the component 296 and the coupling portion 274 is disposed on an accessible side of the component 296. After the fastener 272 is installed onto the component 254, solder 306 is deposited within the notches 286 to create a strong electrical connection between the fastener 272 and the vehicle component 296. The fastener 272 may also be soldered to the component 296 along the periphery of the flange 278.

The ground assembly 270 also includes a grounding lug 298 electrically connected to the circuitry of a vehicle electrical system. The grounding lug 298 may include an eyelet 300 that is received onto the coupling portion 274 to ground the circuitry to the component 296. A wire 302 is connected to the eyelet 300 at one end and is connected to the circuitry at another end. The grounding lug 298 may be secured to the fastener 272 with a bolt or screw 304 that is threaded into the threads 294 of the coupling portion 274.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An electrical ground assembly comprising:
a vehicle component defining a hole;
a fastener including a flange defining an aperture extending completely therethrough and a barrel disposed within the hole, wherein the barrel includes a compressed annular locking ring engaged with a side of the component opposite the flange to form a mechanical interlock; and
solder disposed within the aperture to form an electrical bridge between the component and the fastener.

2. The assembly of claim 1 further comprising a grounding lug attached to the fastener.

3. The assembly of claim 1 wherein the aperture is a notch.

4. The assembly of claim 1 wherein the flange further includes a first surface engaging the component, a second surface opposite the first surface, and a periphery surface extending between the first and second surfaces, and wherein the aperture is a notch recessed into the periphery surface and extending between the first and second surfaces.

5. The assembly of claim 1 wherein the compressed annular locking ring includes a first overlapping section and a second overlapping section joined at a bend and wherein the second overlapping section engages with the side of the component.

6. The assembly of claim 1 wherein the solder is a metal alloy having a melting point less than 840 degrees Celsius.

7. The assembly of claim 1 wherein the barrel further comprises a threaded section extending axially along an inside portion of the barrel and wherein the assembly further comprises a grounding lug attached to the fastener by a bolt received within the threaded section.

8. The assembly of claim 1 wherein the barrel and the flange define a bore having a closed end opposite the flange and wherein the fastener further includes a threaded stud connected to the closed end and disposed within the bore and extending past the flange.

9. A fastener for a vehicle comprising:
an electrical ground rivet nut including a tubular barrel and a flange attached to the barrel, the barrel including a sidewall configured to buckle, during installation, to form a compressed annular locking ring, and the flange defining at least one notch extending completely through the flange.

10. The fastener of claim 9 further comprising solder disposed within the at least one notch.

11. The fastener of claim 9 wherein the flange further includes a first surface configured to engage a component of the vehicle, a second surface opposite the first surface, and a periphery surface extending between the first and second surfaces, and wherein the notch is recessed into the periphery surface and extends between the first and second surfaces.

12. The fastener of claim 9 wherein the compressed annular locking ring includes a first overlapping section and a second overlapping section joined at a bend and wherein the second overlapping section engages with a component of the vehicle.

13. The fastener of claim 9 wherein the fastener further comprises a grounding lug attached to the fastener.

14. The fastener of claim 9 wherein the sidewall of the tubular barrel further includes a threaded section configured to receive a bolt or screw.

15. The fastener of claim 9 wherein the barrel and the flange define a bore having a closed end opposite the flange and wherein the rivet nut further includes a threaded stud connected to the closed end and disposed within the bore and extending past the flange.

16. An electrical ground assembly comprising:
a vehicle component;
a fastener including a coupling portion and a riveting portion axially aligned and separated by a flange defining an aperture extending completely therethrough, wherein the riveting portion is configured to, during installation, pierce through the component and deform to create a mechanical interlock with the component; and
solder disposed within the aperture and joined to the component and the fastener to form an electrical bridge therebetween.

17. The assembly of claim 16 wherein the flange further includes a first surface configured to engage the component, a second surface opposite the first, and a periphery surface extending between the first and second surfaces, and wherein the aperture is a notch recessed into the periphery surface and extending between the first and second surfaces.

18. The assembly of claim 16 wherein the aperture is a plurality of apertures defined in the flange.

19. The assembly of claim 16 further comprising a grounding lug attached to the coupling portion of the fastener.

20. The assembly of claim 16 wherein the solder is a metal alloy having a melting point less than 840 degrees Celsius.
